(19) United States
(12) Patent Application Publication
(10) Pub. No.: US 2005/0032995 A1
(43) Pub. Date: Feb. 10, 2005

(54) Inclusion complexes of cyclic macromolecular organic compounds and polymerization thereof

(76) Inventors: Mohan Gopalkrishna Kulkarni, Pune (IN); Rohini Nitin Karmalkar, Maharashtra (IN); Sunita Suryakant Satav, Pune (IN)

Correspondence Address: HODGSON RUSS LLP, ONE M & T PLAZA, SUITE 2000, BUFFALO, NY, 14203-2391, US

(21) Appl. No.: 10/637,917

(22) Filed: Aug. 8, 2003

(51) Int. Cl. C08F 4/04

(52) U.S. Cl. 526/219.6; 526/319; 526/227; 526/233

(57) ABSTRACT

The present invention relates to an inclusion complex containing monomers with multiple unsaturated and cyclic compound s represented by the general formula Aₓ B_{y}, wherein the monomer containing X units of vinyl unsaturation and B is a cyclic host compound with Y units, and also, a process for the preparation of soluble homo-polymers with unsaturation group from the inclusion complex.

### FIELD OF THE PRESENT INVENTION

The present invention relates to an inclusion complex containing monomers with multiple unsaturated and cyclic compound s represented by the general formula Aₓ B_{y}, wherein the monomer containing X units of vinyl unsaturation and B is a cyclic host compound with Y units, and also, a process for the preparation of soluble homo-polymers with unsaturation group from the inclusion complex.

### BACKGROUND OF THE PRESENT INVENTION

Traditionally polymers have been classified into two categories viz thermoplastics and thermosets depending upon their melting and solubility behavior. The thermoplastics on heating, are converted to a molten state and on cooling return to solid state; reversibly. This property is made use of in shaping the polymers in various forms such as films, sheets, rods and other molded products. Also these polymers are soluble in solvents and can be converted into films by solution casting and solvent evaporation. In contrast, the thermoset products cannot be converted into a molten state or dissolved in solvents. Although these materials offer enhanced mechanical and thermal properties over the thermoplastics, they cannot be readily processed into finished products using processing techniques, commonly used in the case of thermoplastics. Similarly the properties of the thermoplastics cannot be significantly enhanced after converting the resins into finished products since there is no scope to modify the polymer structure chemically after the polymerization is completed.

In few cases such as the phenolics, ureas and melamines, a two stage process is adopted whereby polymerization is first limited to a stage where the polymer can be fused into a molten state or dissolved in a solvent and then cross linked further into an infusible, insoluble product which has enhanced mechanical and thermal properties.

Thermosetting polymers containing reactive groups are used as coatings. These polymers are usually in the form of lattices that are further crosslinked either thermally or by addition of functional groups like isocyanates, amines or metal ions. By formation of a network these resins attain their desired properties i.e., insolubility in most organic solvents, good water resistance and hardness (Van E. S. J. J. in Polymeric Dispersions: Principles and Applications. Asua, J. M. (Ed), Kluwer Publishers, 1997, p. 451; Ooka, M., Ozawa, H. Progress in Organic Coatings. vol 23 , 1994, p.325). Photosensitive groups like cinnamoyl or azo type do not undergo thermal free radical polymerization but can be polymerized by UW irradiation. Polymers containing these functional groups can be cured by exposure to UW irradiation (Mueller, H., Mueller, T., Nuyken, O. Makromolecular. Chem. Rapid. Communications., 13, 289, 1992; Raanby, B in Current Trends in Polymer Photochemistry. Norman, Allen (Ed), London, UK, 1995, p.23). These materials can be used for non linear optics.

In the case of unsaturated polyester resins, a polyester resin containing unsaturated sites is prepared by condensation polymerization using maleic anhydride and/or fumaric acid as the acid component. The resin, diluted with other vinyl monomers such as styrene, methyl methacrylate, allyl acrylate etc. is cast into the desired form and then polymerized further to a crosslinked product in the presence of free radical initiators and accelerators/activators. While these resins are routinely used in the electrical and automobile industry, their scope is restricted. A large number of monomers such as styrene, methyl methacrylate, acrylonitrile, vinyl acetate, hydroxyethyl methacrylate, acrylamide and so on when polymerized by conventional methods of free radical polymerization result in solvent soluble melt fusible resins which can be then converted to desired products.

But as mentioned earlier, these products cannot be subsequently transformed into insoluble, infusible products, since there are no potential polymerizable sites present in the structure. On the other hand polymerization of these monomers with monomers containing multiple unsaturated sites viz ethylene glycol dimethacrylate, divinyl benzene, allyl acrylate, vinyl methacrylate results in the formation of three dimensional crosslinked products which cannot be further converted into useful forms since they are neither soluble in solvents nor are they converted into a molten state on the application of heat.

The need for polymers which are solvent soluble and thermally fusible and which could be later converted into products having enhanced mechanical/thermal/solvent resistance properties is increasing with growing applications of polymers in the field of electronics, photoresists, controlled release delivery systems, micro electro mechanical systems (MEMS) etc.

Injectable polymer based ceramics are being increasingly investigated for fabrication of high temperature MEMS (Liew, L. A.; Zhang, W. L: Bright, V. M., Linan, A., Dunn, M. L. Raj, R.; Sensors and Actuators A 89, 64, 2001). Polymeric precursors are converted to high performance ceramic microstructures using soft lithography (Yang, H; Deschatelects, P; Brittain, S. T. and Whitesides, G. M., Advanced Materials, 13,54 2001). It therefore follows that there is a need to develop methodologies, which will help manipulate properties of polymers for applications in MEMS devices.

In the microstereolithography process, three dimensional microstructures are constructed by solidifying the liquid monomers e.g., Zhang et al fabricated micro gears using microstereolithography (Zhang, X; Juang, X. N,, Sun, C. Sensors & Actuators, A, 77, 149, 1999). In micro fluidic devices, polymers offer versatility and ease of processing over glass (Saper, S. A.; Ford, S. A., Qi, S. McCarley, R. L., Kelly, K. and Murphy, M. C.; Analytical Chemistry, 72, 643 A, 2000).

In the field of controlled release delivery system a drug coated from a polymer solution or a dispersion to provide a coating can then be cross linked as to present a barrier for the permeation of the drug from the coated layer and thus manipulate the rate of release of the drug from the device.

Nanoparticles constitute an important building block for materials to be used in medical, mechanical and electronic applications (Xia, Y., Gates, B., Yin, Y;, Lu, Y., Advanced Materials, 12, 693, 2000). Mecerreyes et al synthesized nanoparticles by self cross linking of polymers in dilute solutions. In this approach, acrylate/methacrylate pendant groups were created on polymer backbone and subsequently polymerized to generate self cross linked polymer particles (Meccereyes, D., Lee, V., Hawker, C. J., Hedrick, J. L.; Wursch, A; Volksen, V, Magbitang, T; Huang, E., Miller, R. D., Advanced Materials, 13, 204, 2001).

In yet another approach, Wooley (Wooley, K. L., J Polym. Sci. A, Polymer Chemistry, 38, 1397 2000), prepared shell crosslinked knedels by organizing the polymers into micellar assemblies and then bringing about intramicellar crosslinking. Clearly, polymers which can be solubilized and contain unsaturated sites which can be subsequently polymerized, is an important class of materials which has a wide range of applications.

Free radical polymerization of monomers comprising multiple unsaturated groups leads to insoluble polymers. There are few reports on the controlled polymerization of monomers containing multiple unsaturated groups using anionic polymerization. Thus anionic polymerization of 1,4 divinyl or 1,4-diisopropenylbenzene gave reactive microgels containing high amount of pendant vinyl groups. But this method is restricted to divinyl compounds, which are amenable to anionic polymerization (Hiller, J. C., Funke, W. Angew. Makromolecular. Chemistry., 76/77, 161, 1979; Wolfgang, S. Funke, W. Makromolecular. Chemistry., 179, 2145, 1978) and requires monomers of extremely high purity and very low temperature.

Recently Guan (2002) reported the synthesis of hyper branched polymers by cobalt mediated free radical polymerization of ethylene glycol dimethacrylate (Guan, Z. Journal of American Chemical Society. 124, 5616, 2002) which resulted in a soluble polyethylene glycol dimethacrylate polymer containing unsaturation. However, this method is specific to ethylene glycol dimethacrylate and cannot be readily extended to other monomers containing multiple unsaturated sites.

A wider range of cyclic compounds such as cyclodextrins, calixarenes, cryptands, and crown ethers are known to form host guest complexes and have been widely exploited commercially e.g., a number of drugs which are poorly water soluble and hence are poorly absorbed in the body have been encapsulated in the cyclodextrin cavity. The enhanced solubility leads to enhanced bioavailability of the drug. Crown ethers can form complexes with potassium ions. Similarly calixarenes form complexes with organic molecules like toluene, benzene in relation to the ring size (Bradshaw, J. S Comprehensive Supramolecular Chemistry. Vol.1, 35, 1996, Odashimo, K., Koya, K. Comprehensive Supramolecular Chemistry. Vol 2, 143, 1996, Pochini, A., Ungaro, R. Comprehensive Supramolecular Chemistry. Vol. 2, 103, 1996).

Cyclodextrins are well known cyclic oligosaccharides that can solubilize hydrophobic compounds in aqueous media (Wenz, G. Angew Chem. 106, 851, 1994). The solubilization is effected by complexation of the water insoluble species within the hydrophobic cavity of cyclodextrin. The use of cyclodextrin to dissolve suitable monomers in water has been described in the literature (Storsberg, J., Ritter, H. Macromolecular. Rapid. Communications. 21, 230, 2000., Jeromin, J., Ritter, H. Macromolecular. Rapid. Communications. 19, 377, 1998., Jeromin, J., Noll, O., Ritter, H. Macromolecular. Chemistry&. Physics 199, 2641-1998., Glockner, P., Ritter, H. Macromolecular. Rapid. Communications, 20, 602, 1999). Some patents describe the use of cyclodextrin preferably in catalytic amounts in order to improve emulsion polymerization yields (Lau. W Eur. Pat Appl Rohm & Haas, 1996, Ger Offen., BASF AG, Ludwigshafen, 1997, U.S. Pat. No. 6,225,299, 1^{st}, May, 2000, U.S. Pat. No. 6,040409, 7^{th} May, 1998). But the preparation of host-guest complexes comprising monomers containing multiple unsaturation and cyclic compounds has not been reported till date.

We have surprisingly found that monomers which contain multiple unsaturation form inclusion complexes of varying stoichiometries with cyclodextrins. Further the unsaturated sites encapsulated within the cyclodextrin cavity do not react with the growing free radical chain. The polymerization of inclusion complexes of vinyl monomers containing multiple unsaturation, therefore leads to soluble polymers containing unreacted unsaturated sites. Once the cyclodextrin is removed from the system, the deprotected, unsaturated site can participate in polymerization in the second stage and lead to cross linked products having enhanced mechanical, thermal and solvent resistance characteristics. These polymers therefore, offer the ease of processing of thermoplastics and enhanced properties of thermosets.

### OBJECTS OF THE PRESENT INVENTION

The principle object of the present invention to develop inclusion complexes of cyclic macromolecular compounds and monomers comprising multiple unsaturated groups.

Another object of the present invention is to develop a method for the preparation of soluble polymers from the complexes so formed using the free radical polymerization methods.

### SUMMARY OF THE PRESENT INVENTION

The present invention relates to an inclusion complex containing monomers with multiple unsaturated and cyclic compound s represented by the general formula Aₓ B_{y}, wherein the monomer containing X units of vinyl unsaturation and B is a cyclic host compound with Y units, and also, a process for the preparation of soluble homo-polymers with unsaturation group from the inclusion complex.

### DETAILED DESCRIPTION OF THE PRESENT INVENTION

Accordingly, the present invention relates to an inclusion complex containing monomers with multiple unsaturated and cyclic compound s represented by the general formula Aₓ B_{y}, wherein the monomer containing X units of vinyl unsaturation and B is a cyclic host compound with Y units, and also, a process for the preparation of soluble homo-polymers with unsaturation group from the inclusion complex.

In an embodiment of the present invention, wherein an inclusion complex containing monomers with multiple unsaturated and cyclic compound represented by the general formula Aₓ B_{y} wherein A is a monomer containing X units of vinyl unsaturation and B is a cyclic host compound with Y units.

In another embodiment of the present invention, wherein the value of X and Y units are 0<x<5 and value of Y is 3<y<9 respectively.

In yet another embodiment of the present invention, wherein the ratio of Aₓ to B_{y} is in the range of 1:0.1 to 1:10.

In still another embodiment of the present invention, wherein the preferable ratio of Aₓ to Bᵥ is 1:1.

In still another embodiment of the present invention, wherein inclusion complex can be converted into soluble homo-polymers with free unsaturated groups by free radical polymerisation.

In still another embodiment of the present invention, wherein a process for the preparation of soluble homo-polymers with unsaturation group from an inclusion complex of claim 1, the said process comprising steps of:
a) dissolving with stirring cyclic compound or its derivative in water at ambient temperature,
b) adding stoichiometric amount of monomer with multiple unsaturation to the solution of step (a),
c) stirring the mixture of step (b) at a temperature range of 20° to 30° C. for a period of 24-28 hours,
d) separating the complex formed in step (c) by conventional methods,
e) washing the complex of step (d) with water, followed by an organic solvent,
f) drying the solvent washed complex of step (e) to obtain the required inclusion complex.
g) dissolving the inclusion complex of step (f) in a polar aprotic solvent,
h) adding azoredox or peroxide initiator to the solution of step (g) under nitrogen purging,
i) heating the mixture of step (h) at a temperature range of 50° C. to 70° C. for a
j) period of 16 hrs to 24 hrs.
k) pouring the reaction mixture of step (i) into water to precipitate the homo-polymer and
l) separating precipitated homo polymer of step (j) by filtration,

In still another embodiment of the present invention, wherein in step (a) the cyclic compound is a macromolecular organic compound selected from a group consisting of cyclodextrin, crown ethers, cryptands. cyclohanes or their derivatives.

In still another embodiment of the present invention, wherein in step (b) the monomer with unsaturation is selected from a group consisting of dimethacylate, trimethacrylate, tetramethacylate, ethylene glycoldimethacylate, divinyl benzene, trimethylol propane trimethaacrylate, pentacrylthrilol tetraacrylate, penta crythriol trimethacylate, pentaacrythilol tetrametha acrylate, bisphenol, dimethacrylate, glycerol diacrylate, vinyl methacrylate, vinyl acrylate, trimethylol, propane acrylate or pentaacrytllrilol tetramethylacrylate, bisphenol dimethacrylate, glycerol dimethacrylate, glycerol diacrylate, vinyl methacrylate, vinyl acrylate, trimethylol propane acrylate or pentacrythrilol tetraacrylate.

In still another embodiment of the present invention, wherein in step (e) the organic solvent is selected from a group consisting of acetone, ethyl alcohol, methanol or tetrahydro furan.

In still another embodiment of the present invention, wherein in step (g) the polar aprotic solvent is selected from a group consisting of N, N-dimethyl formamide or dimethyl sulphoxide.

In still another embodiment of the present invention, wherein in step (h) azoredox or peroxide initiator is selected from the group consisting of azobisisobutyronitrile, benzoyl peroxide, t-butylhydroperoxide or potassium persulphate.

In still another embodiment of the present invention, wherein in step (i) the homopolymer obtained has unsaturated group present in it.

In still another embodiment of the present invention, wherein in step (k) the homopolymer obtained is soluble in organic solvent.

In still another embodiment of the present invention, wherein in step (e) the photochemical initiator used is selected from group consisting of 1-hydroxy cyclohexyl phenyl ketone or benzophenone.

The present invention relates to an inclusion complex containing monomers with multiple unsaturated and cyclic compound s represented by the general formula Aₓ B_{y}, wherein the monomer containing X units of vinyl unsaturation and B is a cyclic host compound with Y units, and also, a process for the preparation of soluble homo-polymers with unsaturation group from the inclusion complex.

The present invention provides soluble homo-polymers of di, tri or tetra functional cross linkers containing unsaturation, and the synthesis thereof. More particularly it relates to the inclusion complexes comprising monomers with multiple unsaturation, their synthesis and polymerization thereof leading to the preparation of soluble polymers. The process involves preparation of inclusion complexes of the monomers with cyclic organic compounds and subsequent polymerization of the complexes with a suitable polymerization initiator.

This invention relates to inclusion complexes of cyclic macromolecular organic compounds and polymerization thereof. More particularly it relates to the said inclusion complexes, the process for their synthesis and their polymerization. Still more particularly it relates to the complexes comprising cyclodextrins and monomers containing multiple unsaturation sites, the process for the preparation thereof and the synthesis of soluble polymers using these complexes.

The polymers so prepared can be further cast into film, made into microspheres or any desired shape and further converted into cross-linked insoluble products in the second stage. Polymers prepared under identical conditions using conventional methods lead to insoluble products which can not be further cast into films or converted into microspheres or any desired shape. The invention includes the preparation of complexes comprising monomers with multiple unsaturations and cyclic organic compounds, as illustrated by cyclodextrins. Polymerization of the complexes is carried out using a suitable free radical initiator. The polymers formed are soluble in common solvents and contain unsaturated groups, which can be further polymerized in a second step.

Accordingly the present invention provides inclusion complexes having general formula AxBy, comprising of monomers containing multiple unsaturation and a cyclic compound, wherein A is a monomer containing number of vinyl unsaturation x where 0<x<5 and wherein B is the cyclic host molecule comprising y units, where 3<y<9 and the ratio of Ax to By varies in the range 1:0.1 to 1:10.

The present invention provides a process for the preparation of inclusion complex comprising dissolving a cyclic compound or its derivatives in water at room temperature optionally under agitation, adding stoichiometric amount of the monomer with multiple unsaturation to this solution and stirring the mixture for 24-48 hrs. at temperature in the range 20° C. to 30° C., separating the complex by conventional methods, washing with water, followed by a organic solvent, drying the complex to obtain the inclusion complex.

In yet another embodiment of the present invention the cyclic compound may be a macromolecular organic compound exemplified by cyclodextrin, crown ethers, cryptands, cyclophanes or their derivatives.

In yet another embodiment the monomer may be di, tri or tetra acrylates, exemplified by ethylene glycol dimethacrylate, trimethylol propane trimethacrylate, pentaerythritol tetra acrylate, pentaerythritol tetramethacrylate, bisphenol A dimethacrylate, glycerol dimethacrylate, glycerol diacrylate, vinyl methacrylate, vinyl acrylate, trimethylol propane acrylate, pentaerythritol tetracrylate, aromatic divinyl compound as exemplified by divinyl benzene.

In another embodiment of the present invention the inclusion complex wherein the monomer is a diacrylate, triacrylate, tetraacrylate, dimethacrylate, trimethacrylate, tetra methacrylate and aromatic vinyl compounds exemplified by ethylene glycol dimethacrylate, divinyl benzene, trimethylol propane trimethacrylate, pentaerythritol tetra acrylate, pentaerythritol trimethacrylate, pentaerythritol tetramethacrylate, bisphenol A dimethacrylate, glycerol dimethacrylate, glycerol diacrylate, vinyl methacrylate, vinyl acrylate, trimethylol propane acrylate, pentaerythritol tetraacrylate.

In still another embodiment the solvent used for washing may be aliphatic alcohols ketones or water exemplified by methanol, ethanol, acetone or water.

In still another embodiment the inclusion complexes may be polymerized by dissolving in polar aprotic solvents like N, N dimethyl formamide, dimethyl sulfoxide using azo, redox or peroxide type initiators, exemplified by azobisisobutyronitrile, benzoyl peroxide, t-butyl hydroperoxide, potassium persulfate.

In still another embodiment the polymerization of the inclusion complexes leads to polymers containing free unsaturated groups and are soluble in organic solvents.

In yet another embodiment the above mentioned soluble polymers containing unsaturated groups can be further polymerized using azo, redox or peroxide type initiators, exemplified by azobisisobutyronitrile, benzoyl peroxide, t-butyl hydroperoxide, potassium persulfate.

In yet another embodiment the homo polymers prepared as aforesaid contain unsaturated groups and are solvent soluble.

In yet another embodiment the abovementioned soluble polymers containing unsaturated groups can be further polymerized using uv irradiation and photochemical initiators exemplified by 1-hydroxy cyclohexyl phenyl ketone, benzophenone.

The present invention further provides a process for the preparation of homo polymers by the free radical polymerization methods of the inclusion complexes of claim (1) using a suitable free radical initiator.

The invention provides a process for the preparation of soluble homopolymers, which when prepared by conventional polymerization methods lead to cross linked products.

In another embodiment the inclusion complexes which when polymerized lead to polymers containing free unsaturated groups and are soluble in organic solvents.

In still another embodiment the soluble polymers containing unsaturated groups can be further polymerized using azo, redox or peroxide type initiators, exemplified by azobisisobutyronitrile, benzoyl peroxide, t-butyl hydroperoxide, potassium persulfate.

In a feature of the present invention the conventional methods of polymerization may be:
1. Thermal polymerization in the temperature range 40° C. to 80° C. under inert atmosphere.
2. Polymerization by UV irradiation at temperature in the range 4° C. to 40° C. using photoinitiators.
3. Polymerization by y irradiation in absence of a free radical initiator.
4. Suspension or emulsion polymerization to obtain the polymer in spherical form.

In another feature the scope of the invention is not restricted to monomers containing multiple unsaturation and cyclodextrin or its derivatives and the compositions of the complexes described above.

In yet another feature the non-solvent for precipitation of soluble homo polymer may be ethers, hexanes or aqueous medium as exemplified by diethyl ether, hexane, petroleum ether, tetrahydrofuran.

The invention is described herein below with reference to examples, which are illustrative only and should not be construed to limit the scope of the present invention in any manner.

### Example 1

This example provides the preparation of β-cyclodextrin-ethylene glycol dimethacrylate complex.

11.35 g (0.01 moles) β-cyclodextrin was dissolved in 450 ml distilled water at room temperature. To this 1.98 g (0.01 moles) ethylene glycol dimethacrylate was added in one portion and the mixture was stirred using a magnetic stirrer for 24 hours. The complex precipitated from the solution was filtered under vacuum. The complex was washed thoroughly with distilled water to remove uncomplexed β-cyclodextrin. and with methanol to remove uncomplexed ethylene glycol dimethacrylate. The complex was dried at room temperature in a dessicator. The yield was 75%. The complex was characterized by 200 MHz ¹H NMR and IR. The stoichiometry of the complex was determined from the area of the protons for β-cyclodextrin and ethylene glycol dimethacrylate and found to be 1:1. IR spectroscopy indicated the presence of unsaturation in the complex indicating the formation of inclusion complex of ethylene glycol dimethacrylate and β-cyclodextrin.

### Example 2

This example provides the preparation of β-cyclodextrin-divinyl benzene complex.

11.35 g (0.01 moles) β-cyclodextrin was dissolved in 450 ml distilled water at room temperature. To this 1.6 g (0.01 moles) of 80% 1,4 divinyl benzene in ethyl benzene was added and the mixture was stirred at room temperature for 24 hours. The complex comprising 1,4 divinyl benzene and β-cyclodextrin precipitated from the solution. This was filtered under vacuum, washed with water and with acetone and dried in a desiccator at room temperature. The yield was 80%. The complex was characterized by ¹H NMR, IR. The stoichiometry of the complex was 1:1 as determined by NMR.

### Example 3

This example provides the preparation of β-cyclodextrin-vinyl methacrylate complex.

11.35 g (0.01 moles) β-cyclodextrin was dissolved in 450 ml distilled water at room temperature. To this 1.2 ml (0.01 moles) vinyl methacrylate was added and the mixture was stirred at room temperature for 24 hours. The complex comprising vinyl methacrylate and β-cyclodextrin precipitated from the solution. It was recovered by vacuum filtration. The complex was washed with water and then with ethanol. The complex was dried at room temperature in a vacuum dessicator. The yield was 80%. The complex was characterized by ¹H NMR and IR spectroscopy. The stoichiometry of β-cyclodextrin and vinyl methacrylate in the complex was 1.5:1 as estimated by ¹H NMR.

### Example 4

This example provides preparation of γ cyclodextrin-ethylene glycol dimethacrylate complex.

γ-cyclodextrin 0.648 g (0.0005 moles) was dissolved in 25 ml water. To this 99.2 mg (0.0005 moles) ethylene glycol dimethacrylate was added and the mixture was stirred at room temperature for 24 hours. The complex precipitated as white solid, which was filtered under vacuum and washed with distilled water and subsequently with acetone and dried at room temperature. The yield was 70%.

### Example 5

This example provides the preparation of β-cyclodextrin-trimethylol propane trimethacrylate complex.

11.5 g (0.01 moles) β-cyclodextrin was dissolved in 450 ml distilled water. 3.2 ml (0.01 moles) trimethylol propane trimethacrylate was added to the solution and the mixture was stirred for 24 hours. The complex that precipitated was filtered and washed with water and subsequently with methanol. The yield was 6.7 g (45%). The complex was characterized by ¹H NMR and IR spectroscopy. The stoichiometry of the complex as determined by proton NMR was 1:1 (trimethylol propane trimethacrylate:β-cyclodextrin).

### Example 6

This example provides preparation of β-cyclodextrin-trimethylol propane complex.

11.5 g (0.01 moles) β-cyclodextrin was dissolved in 450 ml distilled water. 1.6 ml (0.005 moles) trimethylol propane trimethacrylate was added to the solution and the mixture was stirred for 24 hours. The complex that precipitated was filtered and washed with water and subsequently with methanol. The yield of the complex was 5.3 g (42%). The stoichiometry of the complex as determined by ¹H NMR was 1:2 (trimethylol propane trimethacrylate: β-cyclodextrin).

### Example 7

This example provides the preparation of α-cyclodextrin-ethylene glycol dimethacrylate complex.

0.973 g (0.001 moles) α-cyclodextrin was dissolved in 25 ml water. To this 0.198 g (0.001 moles) ethylene glycol dimethacrylate was added and the mixture stirred for 36 hours at room temperature. White solid precipitated and was filtered and washed with water. The yield was 6%. The complex was characterized by ¹H NMR and IR spectroscopy.

### Example 8

This example provides the preparation of poly(divinyl benzene).

1 g complex of divinyl benzene and β-cyclodextrin as described in example 2 was dissolved in 6 ml N, N dimethyl formamide in a 20 ml glass tube. 10 mg azobisisobutyronitrile was added and the test tube was flushed with nitrogen for 10-15 minutes. The test tube was immersed in a water bath maintained at 65° C. The polymerization was carried out for 18 hours. After cooling, the solution was added to 75 ml water with stirring. β-cyclodextrin remained in the aqueous layer and the polymer was isolated by filtration. The yield of the polymer was 58%.

### Example 9

This example provides the preparation of poly(ethylene glycol dimethacrylate, EGDMA.

1 g ethylene glycol dimethacrylate/β-cyclodextrin complex as described in example 1 was dissolved in 6 ml N, N dimethyl formamide in test tube. 10 mg azobisisobutyronitrile was added and the test tube was flushed with nitrogen for 15 min. The polymerization was carried out for 20 hours at 65° C. The polymer solution was poured in 80 ml distilled water to precipitate the polymer. Polymer was filtered and dried under vacuum at room temperature. The yield of the polymer was 68%. The structure was confirmed by ¹H NMR and IR spectroscopy. ¹H NMR showed presence of vinyl unsaturation. This was also confirmed by IR spectroscopy. The molecular wt of the polymer as characterized by GPC was M_{w}=1,00754, Mₙ=20,932 and the polydispersity was 4.8.

### Example 10

This example provides the second step polymerization of poly(EGDMA).

0.1 g poly(EGDMA) prepared according to example 9, was dissolved in 8:2 (dimethyl sulfoxide:dichloromethane) and 5 mg photo initiator 1-hydroxy cyclohexyl phenyl ketone was added. The solution was purged with nitrogen for 10 minutes and exposed to UV irradiation for 20 minutes. The polymer was crosslinked and formed a gel in the solvent mixture. This is an indirect evidence for the selective polymerization of one vinyl group in the first stage followed by a second stage polymerization leading to network formation.

### Comparative Example (a)

1 g ethylene glycol dimethacrylate was dissolved in 5 ml N, N dimethyl formamide in a test tube. To this 10 mg azobisisobutyronitrile was added and the test tube was purged with nitrogen for 15 min. The polymerization was carried out for 18 h at 65° C. The polymer was obtained as a crosslinked gel that was insoluble in common organic solvents like chloroform, acetone, and methanol.

### Comparative Example (b)

Ethylene glycol dimethacrylate 0.2 g (1mmoles) and 1.14 g β-cyclodextrin (1mmole) was dissolved in 5 ml N, N dimethyl formamide. To this 5 mg azobisisobutyronitrile was added and nitrogen was bubbled for 10 minutes. The polymerization was carried out at 65° C. for 16 hours. The polymer was obtained as a crosslinked gel that was insoluble.

### Example 11

This example provides the photopolymerization of β-cyclodextrin-EGDMA complex.

1 g ethylene glycol dimethacrylate/β-cyclodextrin complex prepared as in example 1 was dissolved in 6 ml N, N dimethyl formamide in test tube. 10 mg 1-hydroxy cyclohexyl phenyl ketone was added and the test tube was flushed with nitrogen for 15 min. The polymerization was carried out for 15 minutes at room temperature by exposure to UV irradiation. The polymer solution was poured in 80 ml distilled water. Polymer was filtered and dried under vacuum at room temperature. The yield of the polymer was 55%. The structure was confirmed by ¹H NMR and IR spectroscopy. ¹H NMR showed presence of vinyl unsaturation. This was also confirmed by IR spectroscopy.

In an embodiment of the present invention, wherein inclusion complexes having general formula AxBy, comprising of monomers containing multiple unsaturation and a cyclic compound, wherein A is a monomer containing number of vinyl unsaturation x where 0<x<5 and wherein B is the cyclic host molecule comprising y units, where 3<y<9 and the ratio of Ax to By varies in the range 1:0.1 to 1:10.

In still another embodiment of the present invention, wherein a process for the preparation of inclusion complex which comprises dissolving a cyclic compound or its derivatives in water at room temperature optionally under agitation, adding stoichiometric amount of the monomer with multiple unsaturation to this solution and stirring the mixture for 24-48 hrs. at temperature in the range 20° C. to 30° C., separating the complex by conventional methods, washing with water, followed by a organic solvent, drying the complex to obtain the inclusion complex.

In still another embodiment of the present invention, wherein the cyclic compound is a macromolecular organic compound exemplified by cyclodextrin, crown ethers, cryptands, cyclophanes or their derivatives.

In still another embodiment of the present invention, wherein the monomer is a diacrylate, triacrylate, tetraacrylate, dimethacrylate, trimethacrylate, tetra methacrylate and aromatic vinyl compounds exemplified by ethylene glycol dimethacrylate, divinyl benzene, trimethylol propane trimethacrylate, pentaerythritol tetra acrylate, pentaerythritol trimethacrylate, pentaerythritol tetramethacrylate, bisphenol A dimethacrylate, glycerol dimethacrylate, glycerol diacrylate, vinyl methacrylate, vinyl acrylate, trimethylol propane acrylate, pentaerythritol tetraacrylate.

In still another embodiment of the present invention, wherein the monomer is a diacrylate, triacrylate, tetraacrylate, dimethacrylate, trimethacrylate, tetra methacrylate and aromatic vinyl compounds exemplified by ethylene glycol dimethacrylate, divinyl benzene, trimethylol propane trimethacrylate, pentaerythritol tetra acrylate, pentaerythritol trimethacrylate, pentaerythritol tetramethacrylate, bisphenol A dimethacrylate, glycerol dimethacrylate, glycerol diacrylate, vinyl methacrylate, vinyl acrylate, trimethylol propane acrylate, pentaerythritol tetraacrylate.

In still another embodiment of the present invention, wherein the solvent used for washing may be aliphatic alcohols, ketones, ethers exemplified by acetone, ethyl alcohol, methanol, tetrahydrofuran.

In still another embodiment of the present invention, wherein a process for the preparation of homo polymers by the free radical polymerization of the inclusion complexes of claim (1) wherein the inclusion complexes are polymerized by dissolving in polar aprotic solvents like N, N dimethyl formamide, dimethyl sulfoxide using azo, redox or peroxide type initiators, exemplified by azobisisobutyronitrile, benzoyl peroxide, t-butyl hydroperoxide, potassium persulfate.

In still another embodiment of the present invention, wherein the homo polymers prepared as aforesaid contain unsaturated groups and are solvent soluble.

In still another embodiment of the present invention, wherein a process for the preparation of cross linked polymers from the homo polymers prepared by the method as aforementioned by conventional polymerization method.

In still another embodiment of the present invention, wherein the homo-polymers obtained by the polymerization of the aforementioned complex wherein the homo polymers prepared as aforesaid contain unsaturated groups and are solvent soluble.

In still another embodiment of the present invention, wherein when polymerized lead to polymers containing free unsaturated groups and are soluble in organic solvents.

In still another embodiment of the present invention, wherein the soluble polymers containing aforementioned unsaturated groups as mentioned, which can be further polymerized using azo, redox or peroxide type initiators, exemplified by azobisisobutyronitrile, benzoyl peroxide, t-butyl hydroperoxide, potassium persulfate.

In still another embodiment of the present invention, wherein the process for further polymerization of soluble polymers containing unsaturated groups as claimed in claim 9 using UV irradiation and photochemical initiators exemplified by 1-hydroxy cyclohexyl phenyl ketone, and benzophenone.

1) An inclusion complex containing monomers with multiple unsaturated and cyclic compound represented by the general formula Aₓ B_{y}, wherein A is a monomer containing X units of vinyl unsaturation and B is a cyclic host compound with Y units.

2) An inclusion complex of claim 1, wherein the value of X and Y units are 0<x<5 and value of Y is 3<y<9 respectively.

3) An inclusion complex of claim 1, wherein the ratio of Aₓ to B_{y} is in the range of 1:0.1 to 1:10.

4) An inclusion complex of claim 1, wherein the preferable ratio of Aₓ to Bᵥ is 1:1.

5) Inclusion complex of claim 1, can be converted into soluble homo-polymers with free unsaturated groups by free radical polymerisation.

6) A process for the preparation of soluble homo-polymers with unsaturation group from an inclusion complex of claim 1, the said process comprising steps of:
a) dissolving with stirring cyclic compound or its derivative in water at ambient temperature,
b) adding stoichiometric amount of monomer with multiple unsaturation to the solution of step (a),
c) stirring the mixture of step (b) at a temperature range of 20° to 30° C. for a period of 24-28 hours,
d) separating the complex formed in step (c) by conventional methods,
e) washing the complex of step (d) with water, followed by an organic solvent,
f) drying the solvent washed complex of step (e) to obtain the required inclusion complex.
g) dissolving the inclusion complex of step (f) in a polar aprotic solvent,
g) adding azoredox or peroxide initiator to the solution of step (g) under nitrogen purging,
h) heating the mixture of step (h) at a temperature range of 50° C. to 70° C. for a period of 16 hrs to 24 hrs.
i) pouring the reaction mixture of step (I) into water to precipitate the homo-polymer and
j) separating precipitated homo polymer of step (j) by filtration,

7. A process of claim 6, wherein in step (a) the cyclic compound is a macromolecular organic compound selected from a group consisting of cyclodextrin, crown ethers, cryptands. cyclohanes or their derivatives.

8. A process of claim 6, wherein in step (b) the monomer with unsaturation is selected from a group consisting of dimethacylate, trimethacrylate, tetramethacylate, ethylene glycoldimethacylate, divinyl benzene, trimethylol propane trimethaacrylate, pentacrylthrilol tetraacrylate, penta crythriol trimethacylate, pentaacrythilol tetrametha acrylate, bisphenol, dimethacrylate, glycerol diacrylate, vinyl methacrylate, vinyl acrylate, trimethylol, propane acrylate or pentaacrytllrilol tetramethylacrylate, bisphenol dimethacrylate, glycerol dimethacrylate, glycerol diacrylate, vinyl methacrylate, vinyl acrylate, trimethylol propane acrylate or pentacrythrilol tetraacrylate.

9. A process of claim 6, wherein in step (e) the organic solvent is selected from a group consisting of acetone, ethyl alcohol, methanol or tetrahydro furan.

10. A process of claim 6, wherein in step (g) the polar aprotic solvent is selected from a group consisting of N, N-dimethyl formamide or dimethyl sulphoxide.

11. A process of claim 6, wherein in step (h) azoredox or peroxide initiator is selected from the group consisting of azobisisobutyronitrile, benzoyl peroxide, t-butylhydroperoxide or potassium persulphate.

12. A process of claim 6, wherein step (i) the homopolymer obtained has unsaturated group present in it.

13. A process of claim 6, wherein in step (k) the homopolymer obtained is soluble in organic solvent.

14. A process of claim 6, wherein in step (e) the photochemical initiator used is selected from group consisting of 1-hydroxy cyclohexyl phenyl ketone or benzophenone.
